(19) United States
(12) Patent Application Publication
(10) Pub. No.: US 2014/0029195 A1
(43) Pub. Date: Jan. 30, 2014

(54) LAPTOP COMPUTER COOLER CASE AND CHARGER

(71) Applicant: Earl Barnes, Washington, DC (US)

(72) Inventor: Earl Barnes, Washington, DC (US)

(21) Appl. No.: 13/950,266

(22) Filed: Jul. 24, 2013

Related U.S. Application Data
(60) Provisional application No. 61/676,528, filed on Jul. 27, 2012.

(51) Int. Cl. G06F 1/16; G06F 1/20

(52) U.S. Cl. CPC G06F 1/1635; G06F 1/203
USPC 361/679.48

(57) ABSTRACT

The laptop computer case according to the present disclosure is an All-in-One Laptop computer cooler case and charger. It is a self-sustaining multipurpose bag that safely stores a laptop computer, cools it down and keeps it charged. The invention may resemble a conventional laptop computer bag, but the unique design allows the computer to fold out and stay connected to the bag's cooling fans at all times. The product allows a user to work long after the computer's battery has depleted, as it can be plugged directly into the backup power supply. People who travel frequently for business or pleasure with their electronic devices in tow may find this unique invention helpful.

### CROSS-REFERENCE TO RELATED APPLICATIONS

This application claims the benefit of U.S. Provisional Application 61/676,528, filed Jul. 27, 2012, the content of which is incorporated herein by reference in its entirety.

### BACKGROUND OF THE INVENTION

Heat can be harmful for all electronic devices. Buying additional products to keep laptop computers safely stored and cool while fully charges can be costly and takes up a lot of space. Also, it can be difficult for a person to find powers sources while in transit of working from various locations. A solution is necessary to allow laptop computer owners to work efficiently while away from home or office.

### SUMMARY OF THE INVENTION

The laptop computer case according to the present disclosure is an All-in-One Laptop computer cooler case and charger. It is a self-sustaining multipurpose bag that safely stores a laptop computer, cools it down and keeps it charged. The invention may resemble a conventional laptop computer bag, but the unique design allows the computer to fold out and stay connected to the bag's cooling fans at all times. The product allows a user to work long after the computer's battery has depleted, as it can be plugged directly into the backup power supply. People who travel frequently for business or pleasure with their electronic devices in tow may find this unique invention helpful.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 is an open view of the laptop computer case with cooling fans.

FIG. 2A is an inside view of the case with the first and second power supply units.

FIG. 2B is an inside view of the case with the first and second power supply units in association with the cooling fans.

FIG. 3 is an inside view of the case with the first and second power supply units in association with the cooling fans.

FIG. 4 is an outside view of the case showing a solar pad.

FIG. 5 and FIG. 6 is an inside view of the case with the first and second power supply units in association with the cooling fans and the solar pad.

FIG. 7 is an outside view of the case with a pocket for holding computer cords.

FIG. 8 is an inside view of the case showing the cooling fan as a single unit.

FIG. 9 is an inside view of the case showing the cooling fan as a single unit containing a battery pack for powering the cooling fan.

FIG. 10 is an inside view of the case showing the cooling fan as a single unit containing a battery pack for powering the cooling and a single 12-volt AC input for supplying power to the computer and other devices.

### DETAILED DESCRIPTION OF INVENTION

The All in One Laptop Computer Cooler Case and Charger provides users with a bag that can keep their computer running smoothly for a longer period of time. The invention comprises a soft-shell laptop bag. Internal fans may be housed in the bottom of the bag with air vents on the front and top. The surface that the laptop rests on may be covered in leather to prevent the computer from becoming scratched. When heat is detected in the bag from the laptop, fans can be activated manually or though a sensor to begin cooling off the unit. When the laptop battery begins to run low, the invention provides a rechargeable power supply to the device though an outlet on the side. The basic design may accommodate laptops of various sizes (i.e. 12″, 14″ or 15″). A hard-shell bag design can be also created that will also be light enough for users to carry anywhere. The exact specifications, materials used, and method of use of the All in One Laptop Computer Cooler Case and Charger may vary upon manufacturing.

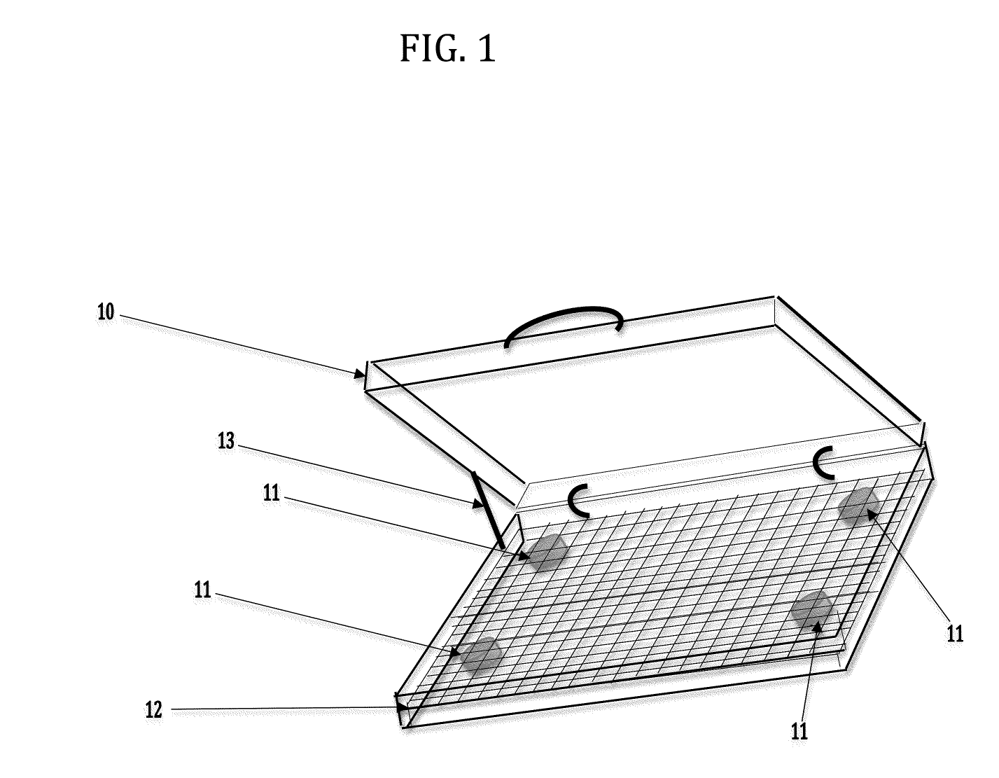

FIG. 1 is a perspective view of the open laptop case 10 comprising the cooling fans 11 located near the corners of the bottom half of the case. Resting on top of the cooling fans is the grill mesh 12 necessary to protect the cooling fans from the weight of the laptop and to provide support for the laptop. The top and bottom parts of the laptop are held together by the hinge 13.

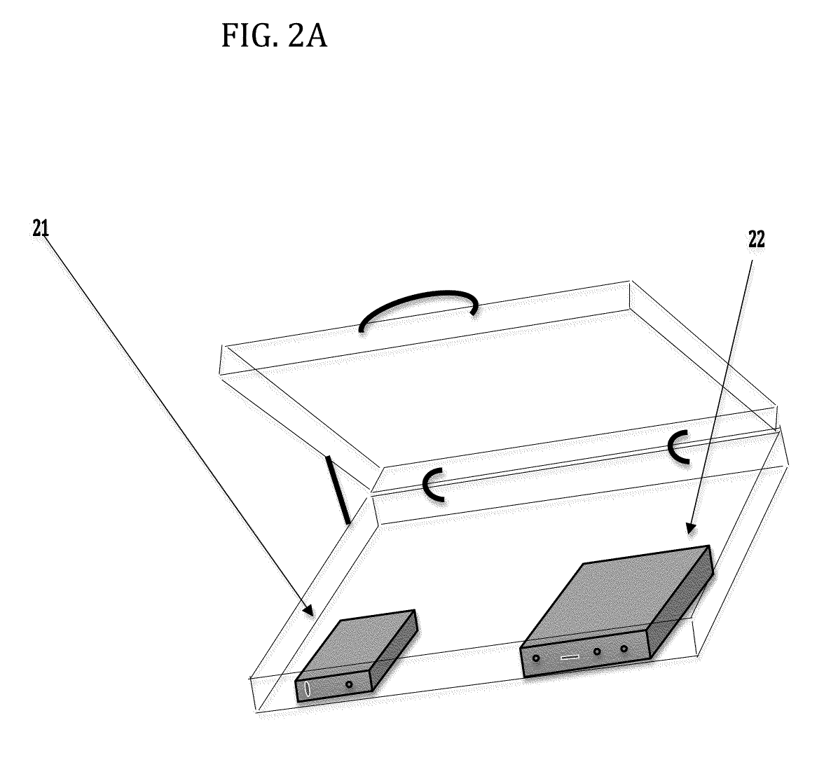

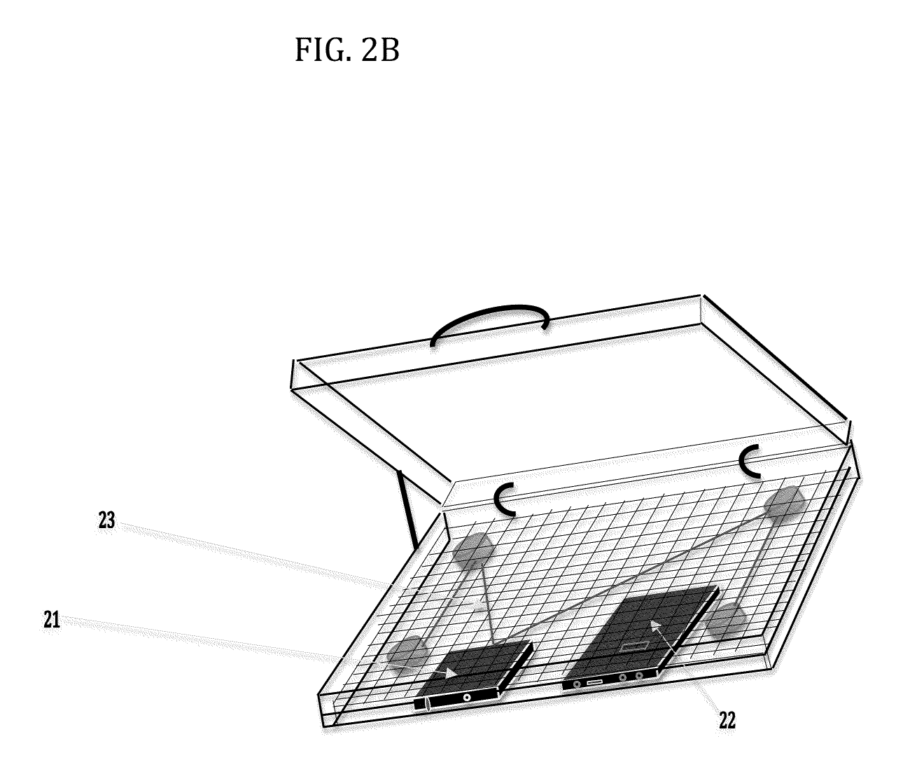

FIG. 2A is a perspective view of the open laptop case comprising the first and second power sources. The first power source 21 is the power source which supplies power to the fans. The second power source 22 is the power sources which supplies power to the computer and phone peripherals.

FIG. 2B is a perspective view of the open laptop case comprising the cooling fans in association with the first and second power sources 21 and 22 respectively and the grill mesh. This figure also shows the wiring diagram 23 for the first power source and the cooling fans.

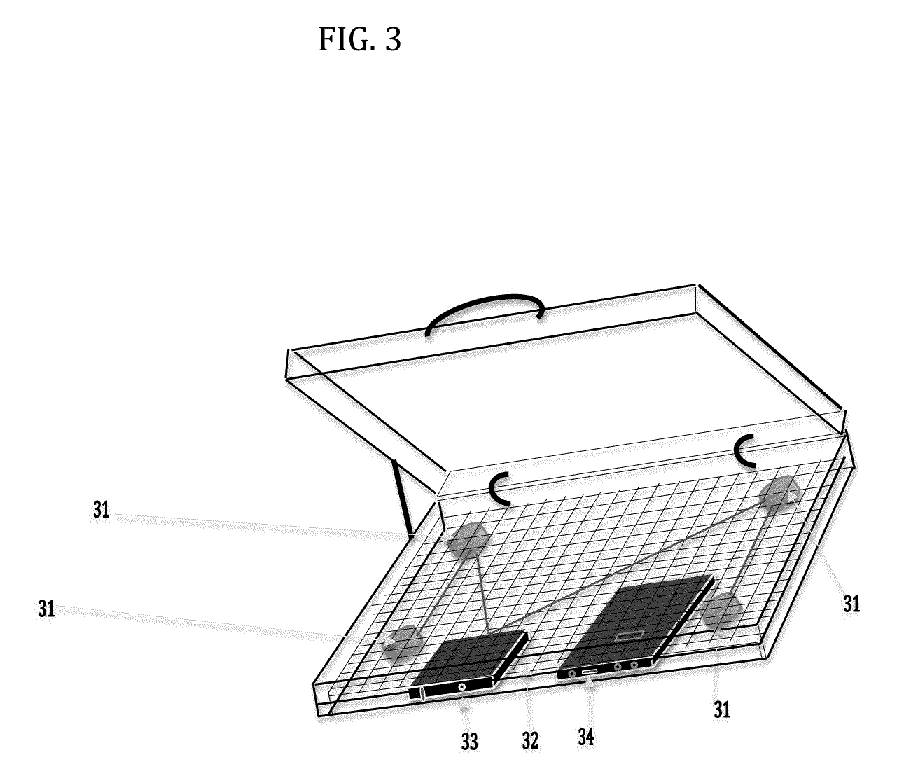

FIG. 3 is one preferred embodiment of the invention. This view of the laptop case shows the first and second power source respectively. On the face of the first power source is an on/off switch 33 and a power adapter jack for charging the first power source. On the face of the second power source is a Universal Serial Bus (USB) 34 receptacle and three female adapter jacks (1 jack charges the power source, 1 jack charges peripheral devices and last jack charges additional peripheral devices. This figure also shows the wiring diagram for the cooling fans 31 and the protective grill mesh 32.

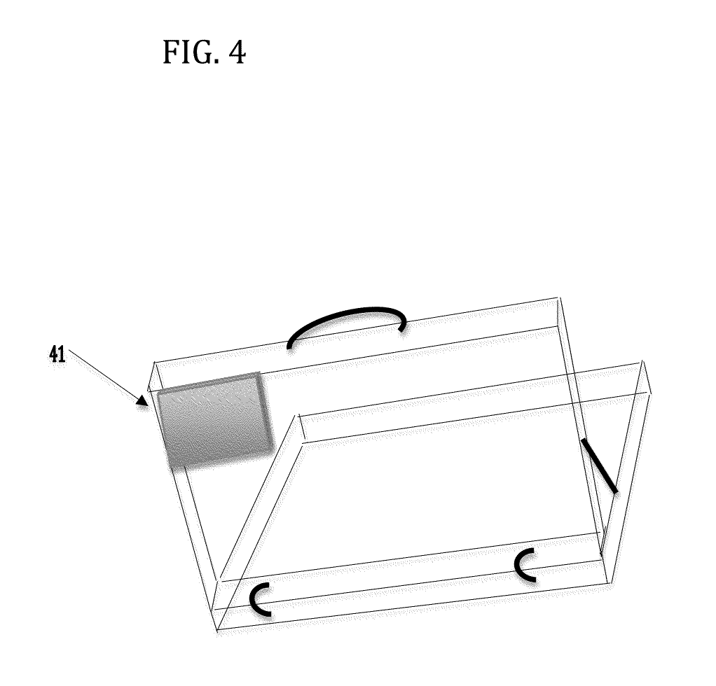

FIG. 4 is a perspective view of the back of the laptop case showing the position of an optional solar panel 41. Positioned inside the top side of the case is a solar pad that can supply additional power to the first and second power sources used to power the computer and the fans.

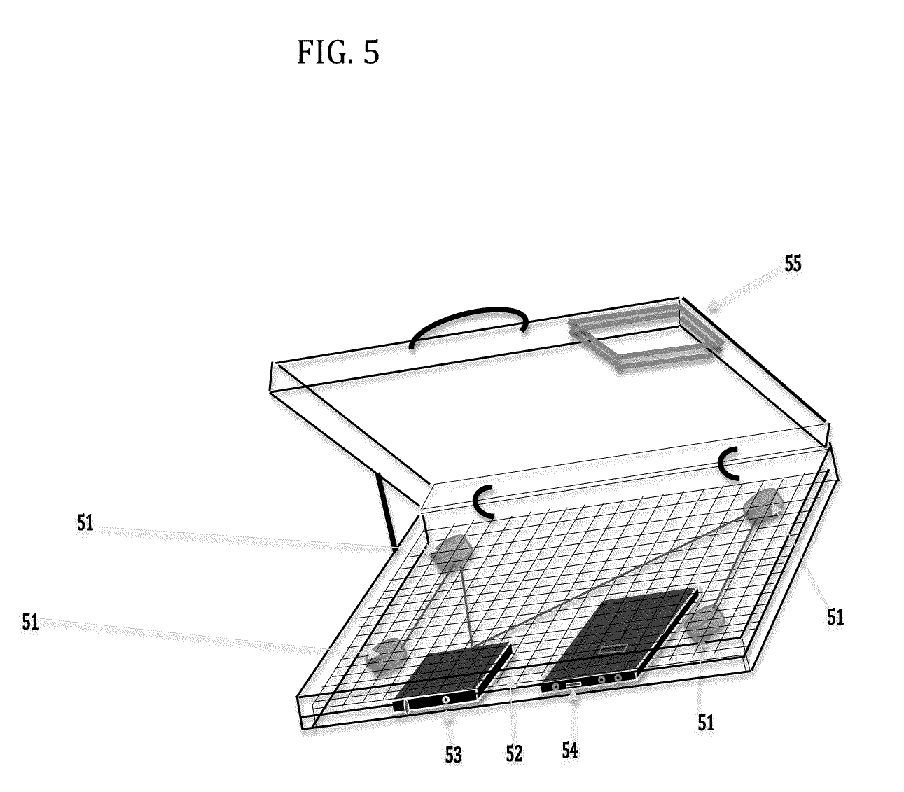

FIG. 5 is another preferred embodiment of the invention. This view of the laptop case shows the first and second power source respectively. On the face of the first power source is a power adapter jack 53 for charging the first power source. On the face of the second power source is a Universal Serial Bus (USB) 54 receptacle and three female adapter jacks (1 jack charges the power source, 1 jack charges peripheral devices and the 1 jack charges additional peripheral devices). This figure also shows the wiring diagram for the cooling fans 51 and the protective grill mesh 52. Together with a solar pad 55 supplying additional power to the first and second power sources.

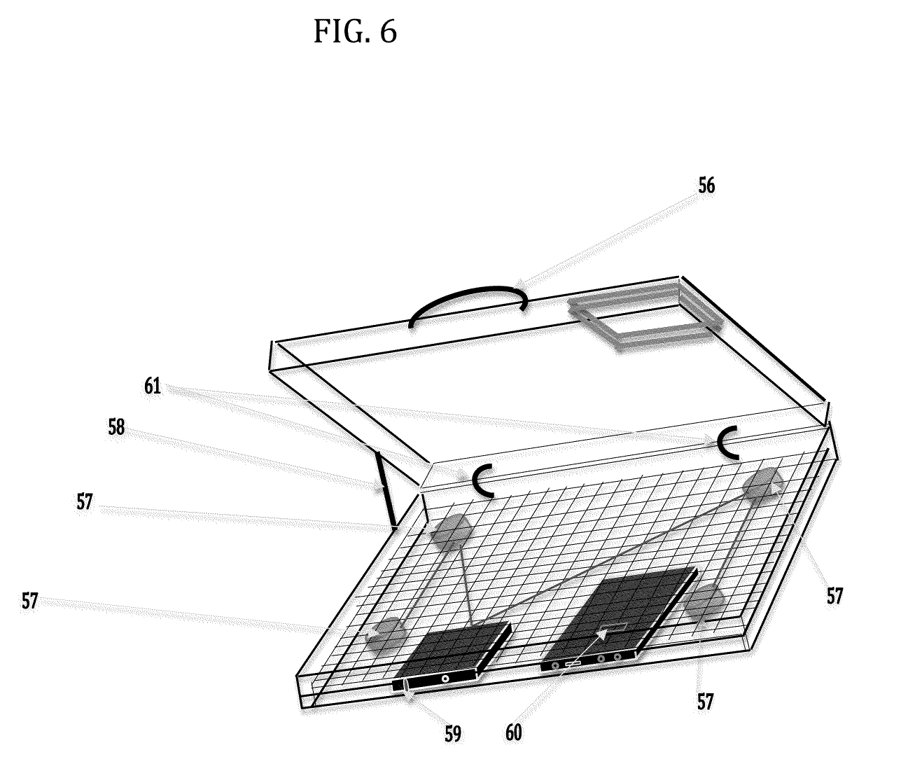

FIG. 6 is another preferred embodiment of the invention. This view of the laptop case shows the first and second power source respectively. On the face of the first power source 59 is an on/off switch and a power adapter jack for charging the first power source. On the top of the second power source 60 is a Light Emitting Diode (LED) monitor which informs the user of the amount of power left in the second power source. This figure also shows the wiring diagram for the cooling fans 57 and the protective grill mesh. Together with a solar pad supplying additional power to the first and second power sources. 58 and 61 shows different types of hinges that comprise the bag. 56 shows the laptop handle associated with the bag.

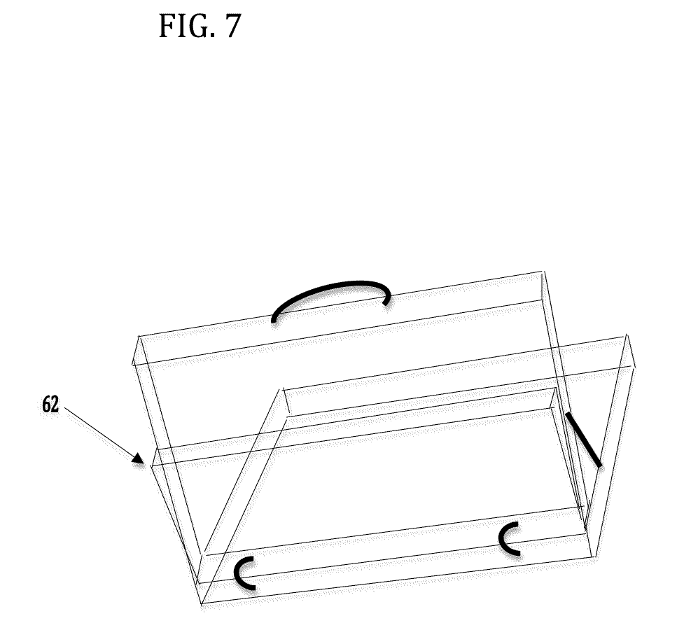

FIG. 7 is a perspective view of the back of the laptop case showing the position of an pocket or pouch 62 which can used for storage of cables or wires necessary for using peripheral devices.

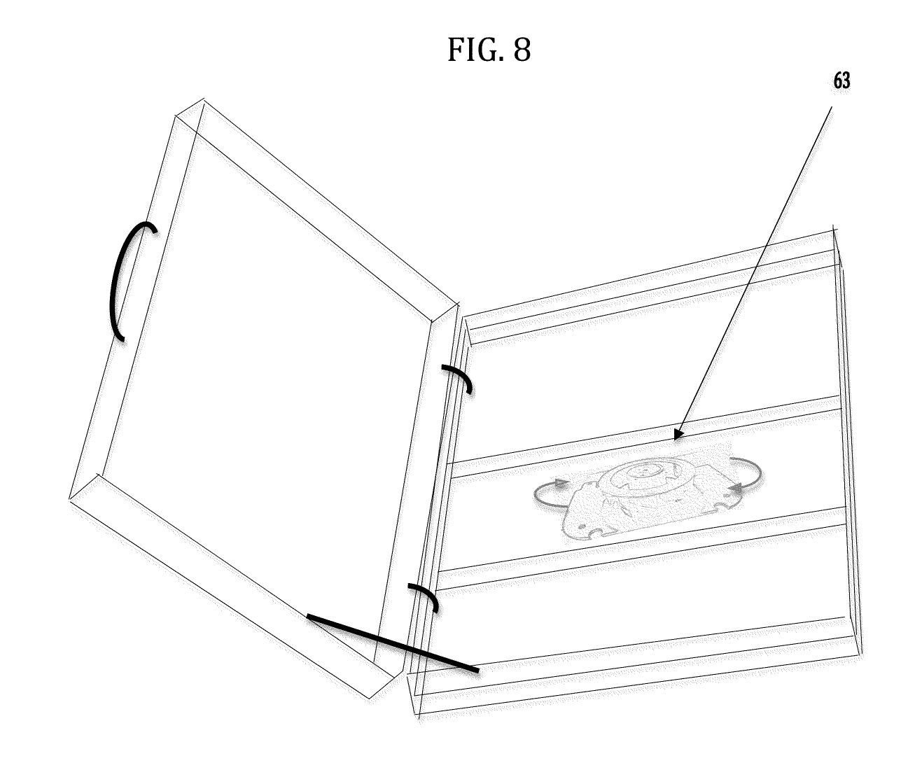

FIG. 8 is another preferred embodiment of the invention. This view of the laptop case shows the cooling fan 63 as a single cooling unit.

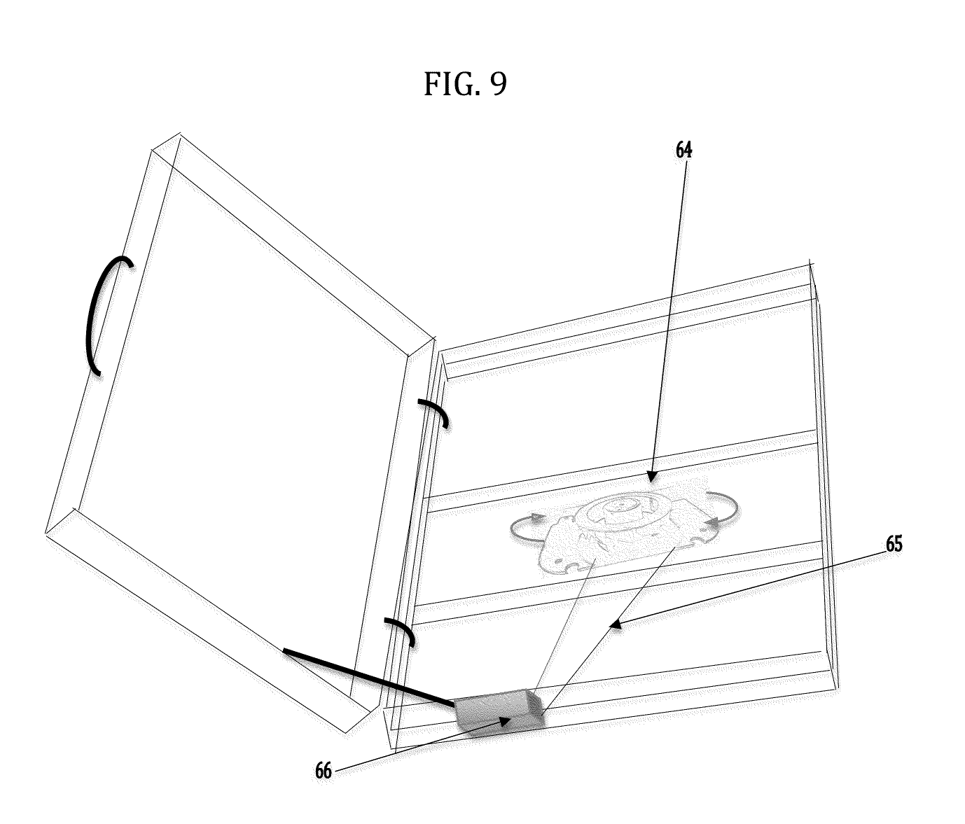

FIG. 9 is a view of the laptop case showing the cooling fan 64 as a single cooling unit. The single cooling fan of this embodiment can be powered with same power source as described in FIG. 2. The single cooling fan of this embodiment can also be powered by a 9-volt battery source 66. 65 shows the electrical connection between the 9-volt battery and the cooling fan.

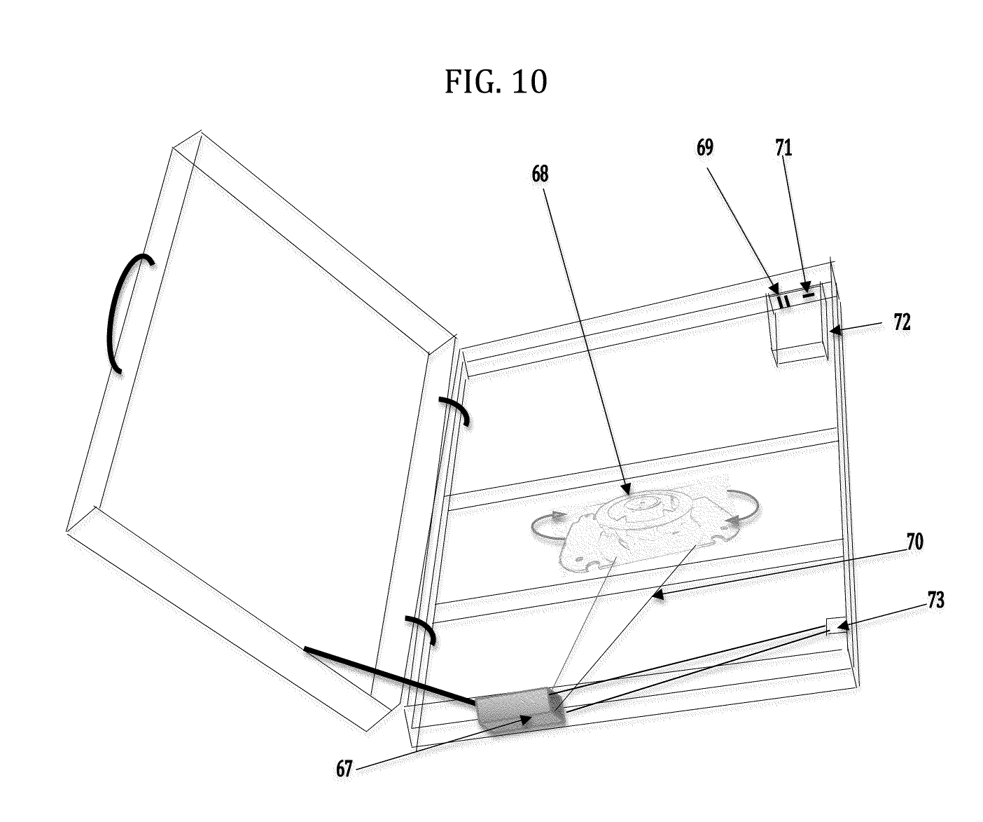

FIG. 10 is a view of the laptop case showing the cooling fan 68 as a single cooling unit. The single cooling fan of this embodiment is powered by a 9-volt battery source 67. 70 shows the electrical connection between the 9-volt battery and the cooling fan. 72 shows a power source that is supplied to the computer and other devices via a single 12-volt AC input 69. 71 is a Universal Serial Bus (USB) receptacle. This power supply is housed under the platform within the case unit and eliminates the need for additional peripheral and wires. 73 shows the On/Off switch for the cooling fan.

It is to be understood that the embodiments described above are for illustrative purposes only and that various modifications and/or changes will be suggested to persons skilled in the art. Additionally, these embodiments are not meant to limit the scope of the invention as claimed. All design configurations as shown above come in hard shell or soft shell designs and also allows the design to be very lightweight in design.

What is claimed is:

1. A laptop computer case comprising:
four cooling fans located on the underside of the case;
a grill mesh styled platform located on top of the cooling fans;
a first power supply unit located adjacent to one set of the cooling fans for supplying power to the fans;
a second power supply unit located adjacent to the other set of cooling fans for supplying power to the
computer and phone.

2. The first power supply of claim 1 further comprises:
a power switch; and
a female adaptor jack for charging the first the power supply.

3. The second power supply of claim 2 further comprises:
a USB receptacle;
a first female adaptor jack for charging a peripheral device;
a second female adaptor jack for charging an additional peripheral device; and
a third female adaptor jack for charging the second power supply.

4. The laptop computer case of claim 3, further comprises:
a solar pad located on the topside of the case.

5. The laptop computer case of claim 4, further comprises:
a storage pocket or pouch.

6. A laptop computer case comprising:
a single cooling fan located on the underside of the case;
a grill mesh styled platform located on top of the cooling fan.

7. The laptop case of claim 6, wherein the cooling fan is powered by a 9-volt battery.

8. The laptop computer case of claim 7, further comprises:
a single 12-volt AC input power supply for powering the computer and other devices.
